(19) United States
(12) Patent Application Publication
(10) Pub. No.: US 2022/0156668 A1
(43) Pub. Date: May 19, 2022

(54) GENERATING SCORES TO EVALUATE USAGE OF MARKETING TECHNOLOGY

(71) Applicant: THE EXPERTS BENCH INC., Suwanee, GA (US)

(72) Inventor: Jodi Lynn Schneider, Duluth, GA (US)

(21) Appl. No.: 17/525,188

(22) Filed: Nov. 12, 2021

Related U.S. Application Data
(60) Provisional application No. 63/113,329, filed on Nov. 13, 2020.

(51) Int. Cl. G06Q 10/06; G06Q 10/10; G06Q 30/02; G06F 3/0482

(52) U.S. Cl. CPC G06Q 10/06393; G06Q 10/105; G06F 3/0482; G06Q 10/06398; G06Q 10/0637; G06Q 30/0201

(57) ABSTRACT

Disclosed are various embodiments for generating scores to evaluate usage of marketing technology. A computing environment receives assessment data from a client device, the assessment data comprising competence values and roles, individual ones of the competence values and individual ones of the roles corresponding to a marketing technology tool from a multitude of marketing technology tools. The marketing technology tools may be classified into one of a plurality of strategies and one of a plurality of categories. The computing environment may determine a competence component based on the competence values; determine a role component based on the roles; determine a skill distribution component based on a number of marketing technology tools classified into respective combinations of individual ones of the strategies and the categories. The computing environment may generate a score based at least in part on the competence component, the role component, and the skill distribution component.

### CROSS-REFERENCE TO RELATED APPLICATIONS

This application claims the benefit of and priority to co-pending U.S. Provisional Application No. 63/113,329, filed on Nov. 13, 2020, and entitled “GENERATING SCORES TO EVALUATE USAGE OF MARKETING TECHNOLOGY,” which is incorporated by reference herein in its entirety.

### BACKGROUND

Various entities, such as users, groups of users, or organizations, may use marketing technology tools to bolster their marketing strategies. Optimizing the usage of these marketing technology tools can allow an entity to improve speed-to-market. However, it may not always be clear whether an entity's usage of its marketing technology tools is optimal.

### BRIEF SUMMARY

Various embodiments are disclosed for generating scores to evaluate usage of marketing technology. A computing environment includes at least one computing device directed to receive assessment data from a client device, the assessment data comprising a plurality of competence values and a plurality of roles, individual ones of the plurality of competence values and individual ones of the plurality of roles corresponding to a marketing technology tool from a plurality of marketing technology tools, individual ones of the plurality of marketing technology tools being classified into one of a plurality of strategies and one of a plurality of categories; determine a competence component based at least in part on the plurality of competence values; determine a role component based at least in part on the plurality of roles; determine a skill distribution component based at least in part on a number of marketing technology tools classified into respective combinations of individual ones of the plurality of strategies and individual ones of the plurality of categories; and generate a score based at least in part on the competence component, the role component, and the skill distribution component.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments.

FIGS. 2A-2D show various examples of user interfaces generated by a client application according to various embodiments.

FIG. 3 illustrates an example of a user interface generated by a client application according to various embodiments.

FIG. 4 illustrates an example flowchart of certain functionality implemented by portions of a scoring application executed in a computing environment in the networked environment of FIG. 1 according to various embodiments.

FIG. 5 is a schematic block diagram that illustrates an example computing environment employed in the networked environment of FIG. 1 according to various embodiments.

### DETAILED DESCRIPTION

In the following paragraphs, the embodiments are described in further detail by way of example with reference to the attached drawings. In the description, well known components, methods, and/or processing techniques are omitted or briefly described so as not to obscure the embodiments. As used herein, the “present disclosure” refers to any one of the embodiments described herein and any equivalents. Furthermore, reference to various feature(s) of the “present embodiment” is not to suggest that all embodiments must include the referenced feature(s).

Among embodiments, some aspects of the present disclosure are implemented by a computer program executed by one or more hardware processors, as described and illustrated. As would be apparent to one having ordinary skill in the art, one or more embodiments may be implemented, at least in part, by computer-readable instructions in various forms, and the present disclosure is not intended to be limiting to a particular set or sequence of instructions executed by the processor.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above. Turning now to the drawings, exemplary embodiments are described in detail.

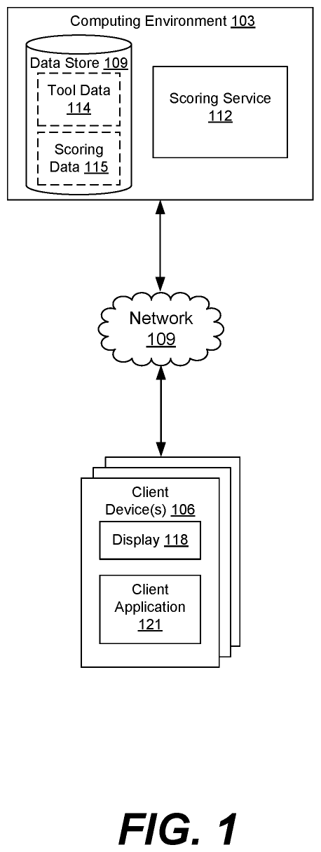

FIG. 1 shows an example of a networked environment 100 according to various embodiments. The networked environment 100 includes a computing environment 103 and client device(s) 106, which are in data communication with each other via a network. The network includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 103 may comprise, for example, a server computer or other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 109 that is accessible to the computing environment 103. The data store 109 may be representative of a plurality of data stores 109 as can be appreciated. The data stored in the data store 109, for example, is associated with the operation of the various applications and/or functional entities described below.

The components executed on the computing environment 103 include a scoring service 112, as well as other applications. The scoring service 112 can be executed to provide a score that can reflect the degree of optimization of a marketing technology stack for an entity, which can be a user, a group of users, or an organization. The score can represent, for example, a breadth or concentration of skills, a level of competence in one or more marketing technology tools, or a role played in the use of one or more marketing technology tools. In some embodiments, the score comprises an alphanumeric value, such as A to Z, A to F, 1 to 100, 1 to 10, or other range of values.

The scoring service 112 can receive data that details an entity's experience with and use of various marketing technology tools. In some examples, the data can be received from a client device 106. The scoring service 112 can store this data in the data store 109 as scoring data 115. The scoring service 112 can generate a score for the entity based on the scoring data 115.

For example, the scoring service 112 can access information from the scoring data 115 that indicates an entity's levels of competence in various marketing technology tools. In some examples, the level of competence for a particular marketing technology tool can be represented by a competence value from a numerical scale, although any suitable representation of an entity's competence may be used, as can be appreciated. The scoring service 112 can aggregate this information to determine the entity's overall competence value across some or all of the various marketing technology tools, which can in some examples be used to determine the competence component of the entity's score. For instance, the scoring service 112 can sum the competence values for each of the various marketing technology tools and determine the competence component of the entity's score based on that sum. It can be appreciated, however, that the scoring service 112 can use any suitable method that provides an aggregate representation of the entity's levels of competence to determine the competence component of the entity's score.

As another example, the scoring service 112 can access information form the scoring data 115 that indicates an entity's role in the use of various marketing technology tools. In some examples, an entity's role with respect to a particular marketing technology tool can be represented by an alphanumeric designation, although any suitable representation of an entity's role may be used, as can be appreciated. The scoring service 112 can aggregate this information to determine what role the entity plays across some or all of the various marketing technology tools, which can in some examples be used to determine the role component of the entity's score. For instance, the scoring service 112 can determine the role played most frequently by the entity and determine the role component of the entity's score based on the most frequent role. It can be appreciated, however, that that the scoring service 112 can use any suitable method that provides an aggregate representation of the entity's role to determine the role component of the entity's score.

As yet another example, the scoring service 112 can access information from the scoring data 115 that indicates how an entity's skills are distributed among the various marketing technology tools. In some examples, the entity's skill distribution can be represented by an alphanumeric designation, although any suitable representation of the entity's skill distribution may be used, as can be appreciated. The scoring service 112 can aggregate this information to determine the distribution of the entity's skills across some or all of the various marketing technology tools, which can in some examples be used to determine the skill distribution component of the entity's score. For instance, the scoring service 112 can determine that an entity's skills are evenly distributed across skills or concentrated in a smaller number of skills. It can be appreciated, however, that the scoring service 112 can use any suitable method that provides a representation of the entity's skill distribution to determine the skill distribution component of the entity's score.

The scoring service 112 can combine one or more scoring components derived from the scoring data 115 to generate the entity's score. In some examples, the scoring service 112 can concatenate one or more components to generate the score. For instance, the scoring service 112 can generate the entity's score by concatenating a competence component, a role component, and a skill distribution component. It can be appreciated, however, that any suitable combination of these or any other score components may be concatenated to generate the entity's score. Likewise, one or more scoring components can be combined by any suitable method that allows the scoring service 112 to represent information conveyed by each of the one or more scoring components in a single score. Once generated, the scoring service 112 can store the entity's score in the data store 109 as scoring data 115.

The scoring service 112 can generate an aggregate score for a group of users. In some examples, the scoring service 112 can generate the aggregate score for the group of users by calculating an average of the individual scores of users in the group. In other examples, the scoring service 112 can generate the aggregate score for the group of users using scoring data 115 for users in the group without generating individual scores for each user. The scoring service 112 can store the aggregate score for the group of users in the data store 109 as scoring data 115.

The scoring service 112 can generate an aggregate score for an organization. In some examples, the scoring service 112 can generate the aggregate score for the organization by calculating an average of the individual scores of users in the organization or by calculating an average of the individual scores of groups of users in the organization. In other examples, the scoring service 112 can generate the aggregate score for the organization using scoring data 115 for users or groups of users in the organization without generating individual scores for each user or group of users. The scoring service 112 can store the aggregate score for the organization in the data store 109 as scoring data 115.

The data stored in the data store 109 can include, for example, tool data 114, scoring data 115, and potentially other data. The tool data 114 can include data regarding one or more marketing technology tools that may be used by an entity. The tool data 114 can include marketing technology tools that are publicly available or proprietary to a particular enterprise or other organization associated with the entity. In some implementations, marketing technology tools may be classified in the tool data 114 based on a category or strategy associated with each marketing technology tool. The tool data 114 can include one or more databases or other data structures.

The scoring data 115 can include information regarding the use of various marketing tools, such as those from the tool data 114, by entities such as users, groups of users, or organizations. For example, the scoring data 115 can include information regarding various marketing technology tools used by an entity, the entity's competence in using those marketing tools, the entity's role in using those marketing tools, and other information as can be appreciated. The scoring data 115 can include one or more marketing technology categories that can represent different aspects of marketing technology. These categories can include, for example, Ad & Promo, Data, Management, Content & Experience, Social & Relationship, and Sales & Commerce. The scoring data 115 can also include one or more strategies that can indicate how a marketing technology tool in a particular category is used. These strategies can include, for example, Attraction, Engagement, and Analysis & Optimization. The scoring data 115 can index an entity's usage data for each marketing technology tool based on a combination of the category and strategy in which the marketing technology tool is implemented. In some examples, this information can be received from a client device 106. In other examples, however, scoring data 115 can be corrected directly by the computing environment 103.

The client device 106 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The client device 106 can include a display 118. The display 118 can comprise, for example, one or more devices such as liquid crystal display (LCD) displays, gas plasma-based flat panel displays, organic light emitting diode (OLED) displays, electrophoretic ink (E-ink) displays, LCD projectors, or other types of display devices, etc.

The client device 106 can be configured to execute various applications such as a client application 121 and/or other applications. The client application 121 can be executed in a client device 106, for example, to access network content served up by the computing environment 103 and/or other servers, thereby rendering a user interface on the display 118. To this end, the client application 121 can comprise, for example, a browser, a dedicated application, etc., and the user interface may comprise a network page, an application screen, etc. The client device 106 can be configured to execute applications beyond the client application 121 such as, for example, email applications, social networking applications, word processors, spreadsheets, and/or other applications.

The client application 121 can enable a user to perform a marketing technology assessment and input data regarding an entity's use of various marketing technology tools, as well as other relevant information as can be appreciated. In some examples, a user interface can be rendered on the display 118 that allows a user to input such data. For instance, the user interface can allow a user to input information regarding which marketing technology tools are used by a particular entity, the entity's role in the use of those marketing technology tools, or the entity's levels of competence in those marketing tools. In other examples, the client application 121 can collect information on an entity's use of various marketing technology tools from information already present on the client device 106, by obtaining this information from other applications executed on the client device 106, by monitoring a user's activity on the client device 106, or by any other suitable method as can be appreciated.

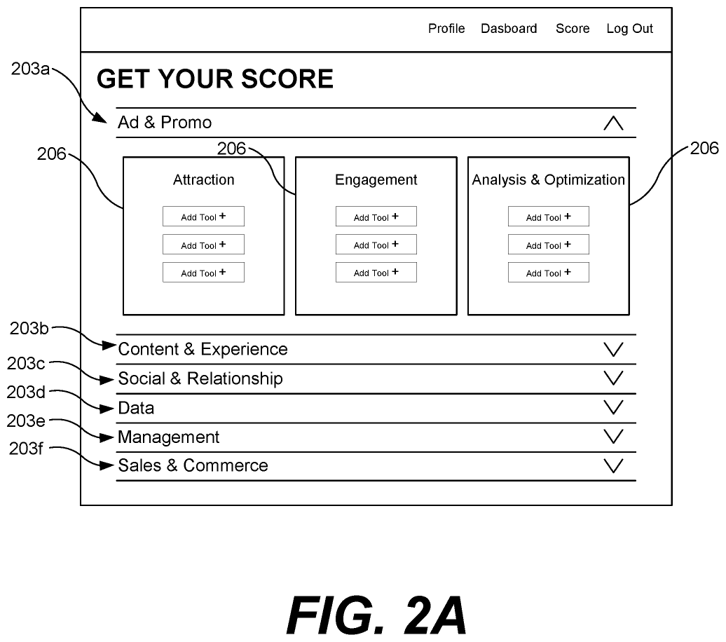

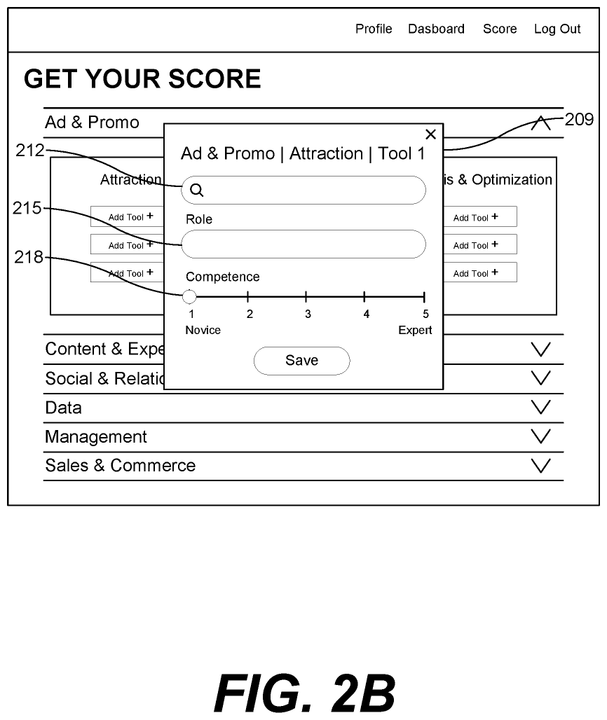

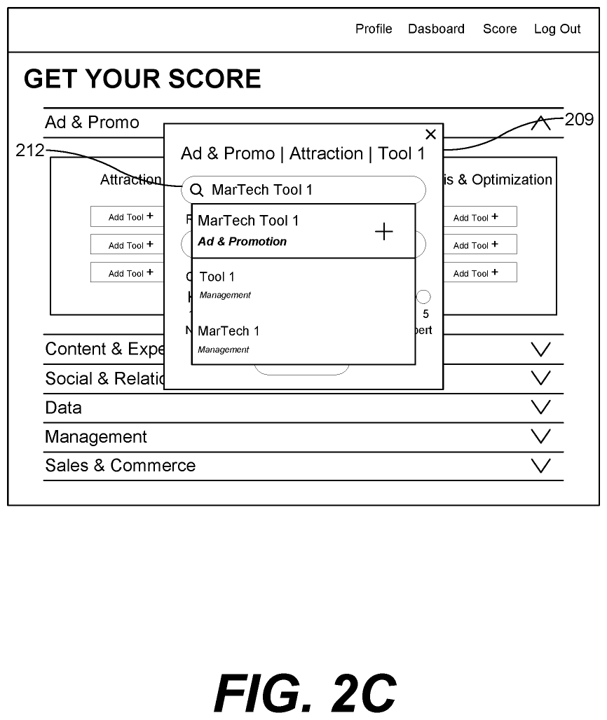

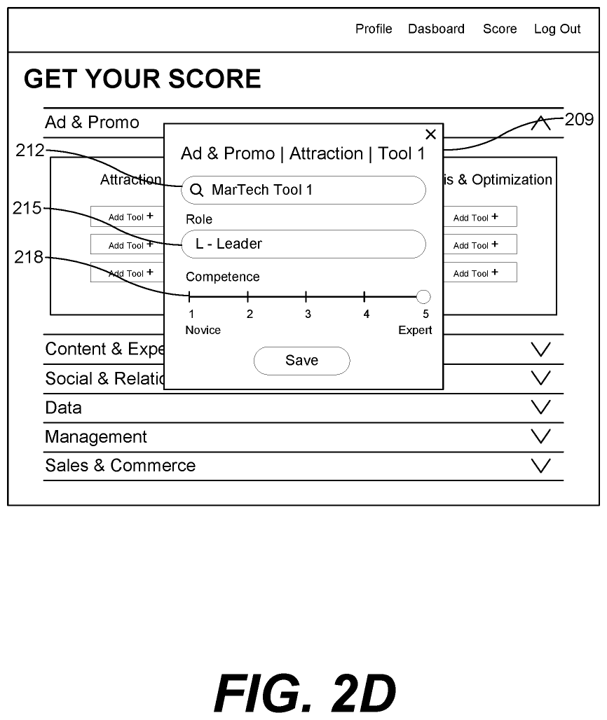

FIGS. 2A-2D show various examples of user interfaces of the client application 121 used collect marketing technology usage data in a marketing technology assessment by prompting the user with various types of user input. In some examples, prior to performing the marketing technology assessment, however, the user may be prompted to provide a username, a password, biometric information, or other information to properly authenticate the user of the client device 106.

FIG. 2A shows an example of a user interface including category tabs 203 that can allow a user to input information about an entity's usage of marketing technology tools for several categories. For example, the category tabs 203 can include an Ad & Promo category tab 203a, a Content & Experience category tab 203b, a Social & Relationship category tab 203c, a Data category tab 203d, a Management category tab 203e, a Sales & Commerce 203f, and any other suitable category tabs 203.

Each of the category tabs 203 can include one or more “Add Tool” interfaces 206 comprising selectable components that allow a user to select one or more marketing technology tools for a category associated with the corresponding category tab 203. The “Add Tool” interfaces 206 can each correspond to a strategy so that a user can add a marketing technology tool under a corresponding strategy. This example shows an “Ad Tool” interface 206 for the Ad & Promo category tab 203a, but a similar user interface for each category tab 203 can be presented. Once a user adds a desired number of marketing technology tools in a particular category tab 203, the user can select another category tab 203 to repeat this process for another category. In some examples, this process can continue until the user has proceeded through each of the category tabs 203.

The example of FIG. 2B shows an example of a tool selector interface 209 that enables a user to input data regarding the entity's use of a specific marketing technology tool. The tool selector interface 209 can be accessed by selecting one of the selectable components in the “Add Tool” interface 206 shown in FIG. 2A. The tool selector interface 209 can enable a user to select a marketing technology tool for a particular strategy and category. The tool selector interface 209 can include, for example, a tool selection element 212, a role selection element 215, and a competence selection element 218. This example shows a tool selector interface 209 for the “Attraction” strategy in the “Ad & Promo” category.

Using the tool selection element 212, the user can select a marketing technology tool for the particular strategy and category. The role selection element 215 can enable a user to select a role that represents an entity's role in using the marketing technology tool from the tool selection element 212. A user can use the competence selection element 218 an entity's level of competence with the marketing technology tool from the tool selection element 212.

The example of FIG. 2C shows another example of a tool selector interface 209 for inputting usage data for a specific marketing technology tool. When the user interacts with the tool selection element 212, a dropdown menu can appear below the search bar and be populated with a list of marketing technology tools for the particular strategy and category. In some examples, the user can input text into the tool selection element 212, and the dropdown menu can repopulate to show marketing technology tools that match the input text. While in FIG. 2C the tool selection element 212 includes a dropdown menu, other graphical control elements or means of selecting a marketing tool may be used. In this example, “MarTech Tool 1” has been selected.

The example of FIG. 2D shows another example of tool selector interface 209 that enables a user to input usage data for a specific marketing technology tool. In the example of FIG. 2D, a user has selected a role and a competence level for the marketing tool selected in FIG. 2C. Using the role selection element 215, the user can select a role from a dropdown menu or other graphical control element. The selected role that describes what role an entity plays in the use of the selected marketing technology tool. In some examples, the roles selectable by the user can indicate that an entity is a Planner, Analyzer, User, Leader, or Implementer. In this example, the “Leader” role has been selected.

The competence selection element 218 can enable a user to select an entity's competence level for the selected marketing technology tools using a slidable component or other graphical control component. The slidable component can be manipulated to select a level of competence between one and five with one representing a “Novice” level of competence and five representing an “Expert” level of competence. In this example, the “Expert” level of competence has been selected.

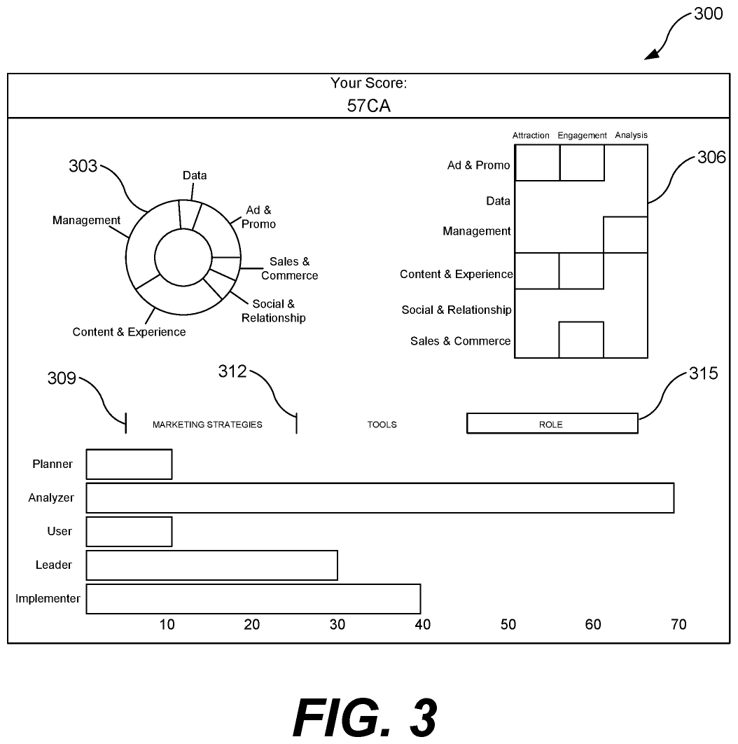

FIG. 3 shows an example of a user interface of the client application 121 that includes a score dashboard 300 that can include an entity's score. The entity's score can be received from the computing environment 103 after the client application 121 sends assessment data from a marketing technology assessment to the computing environment 103. The client application 121 can cause the score dashboard user interface to be rendered on the display 118 of the client device 106 after receiving the entity's score from the computing environment 103.

The score dashboard 300 can also include graphical representations of assessment data for an entity. The graphical representations of the assessment data shown in the score dashboard can include, for example, a doughnut chart 303, a heat map 306, a marketing strategies tab 309 a tools tab 312, and a roles tab 315. The doughnut chart 303 can display the entity's average score for each of the categories. The heat map 306 can display an average of the entity's scores for each combination of category and strategy. The marketing strategies tab 309 can display the average score for each of the strategies. The tools tab 312 can display a list of tools reported. In some examples, the list of tools can be ordered based on which tool has a highest reported score. The role tab 315 can include a graph or other visualization that illustrates a number of times a particular role was reported by an entity.

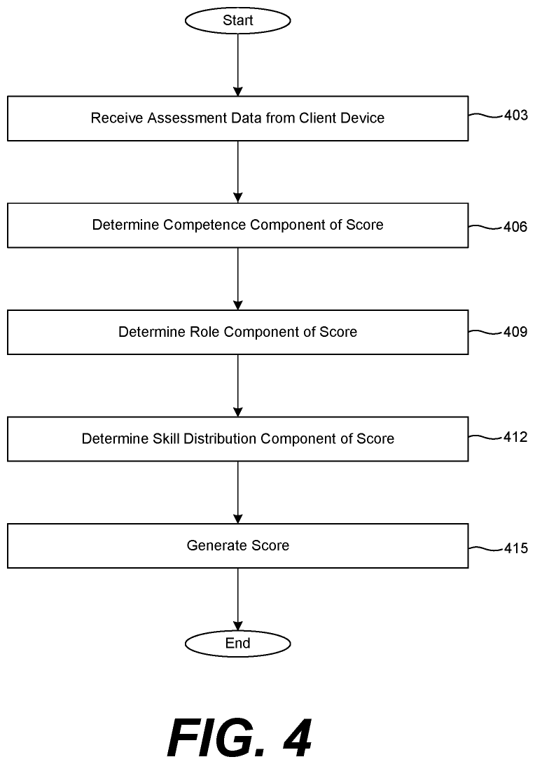

FIG. 4 shows an example of a flowchart that provides one example of the operation of a portion of the scoring service 112 according to various embodiments. It is understood that the flowchart of FIG. 4 provides merely an example of the many different types of functional arrangements that may be employed to implement the operation of the portion of the computing environment 103 as described herein.

At step 403, the scoring service 112 can receive assessment data for a marketing technology assessment from the client device 106. The assessment data can include information regarding an entity's use of various marketing technology tools. As an example, the assessment data can include information regarding what marketing technology tools are used by the entity, what roles the entity takes when using those marketing technology tools, and the entity's level of competence in using each of the marketing technology tools. In some examples, the scoring service 112 can store the assessment data in the data store 109 as scoring data 115.

At step 406, the scoring service 112 can determine a competence component of the entity's score. As an example, the scoring service 112 can obtain information from the assessment data regarding the entity's levels of competence for various marketing technology tools. The scoring service 112 can obtain the sum of the respective levels of competence for some or all of the marketing technology tools. The scoring service 112 can determine the competence component of the entity's score using this sum.

At step 409, the scoring service 112 can determine a role component of the entity's score. As an example, the scoring service 112 can obtain information from the assessment data regarding the entity's roles with respect to various marketing technology tools. The scoring service 112 can determine which role an entity takes most often and determine the role component of the entity's score using the most frequent role.

At step 412, the scoring service 112 can determine a skill distribution component of the entity's score. As an example, the scoring service 112 can obtain information from the assessment data regarding how the entity's skills are distributed among the various marketing technology tools. The scoring service 112 can determine how the entity's skills are distributed across the various combinations of marketing categories and respective strategies. The scoring service 112 can determine the skill distribution component of the entity's score based on whether the entity has multiple skills for each marketing technology category-strategy combination and or whether the entity has skills concentrated in a smaller number of marketing technology category-strategy combinations.

At step 415, the scoring service 112 can generate the entity's score. In some examples, the scoring service 112 can generate the entity's score based on the competence component from step 406, the role component from step 409, and the skill distribution component from step 412. For instance, the scoring service 112 can concatenate the competence component, the skill distribution component, and the role component together to generate the entity's score.

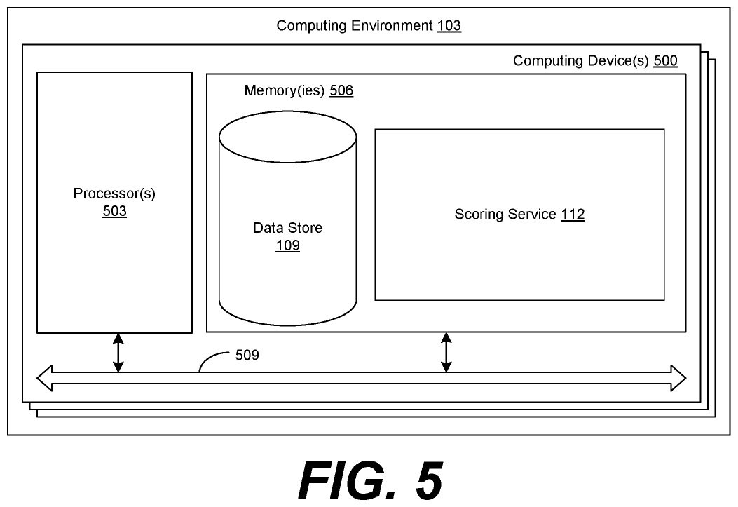

With reference to FIG. 5, shown is a schematic block diagram of the computing environment 103 according to an embodiment of the present disclosure. The computing environment 103 includes one or more computing devices 500. Each computing device 500 includes at least one processor circuit, for example, having a processor 503 and a memory 506, both of which are coupled to a local interface 509. To this end, each computing device 500 may include, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are the scoring service 112 and potentially other applications. Also stored in the memory 506 may be a data store 109 and other data. In addition, an operating system may be stored in the memory 506 and executable by the processor 503.

It is understood that there may be other applications that are stored in the memory 506 and are executable by the processor 503 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the scoring service 112 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 5 shows the functionality and operation of an implementation of portions of the computing environment 103. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the scoring service 112, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the scoring service 112, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or in multiple computing devices in the same computing environment 103. Additionally, it is understood that terms such as “application,” “service,” “system,” “engine,” “module,” and so on may be interchangeable and are not intended to be limiting.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

Therefore, at least the following is claimed:

1. A system, comprising:
at least one computing device comprising at least one hardware processor; and
program instructions stored in memory and executable by the at least one hardware processor that, when executed, direct the at least one computing device to:
receive assessment data from a client device, the assessment data comprising a plurality of competence values and a plurality of roles, individual ones of the plurality of competence values and individual ones of the plurality of roles corresponding to a marketing technology tool from a marketing technology tool database, the marketing technology tool database classifying individual ones of a plurality of marketing technology tools into one of a plurality of strategies and one of a plurality of categories;
determine a competence component based at least in part on the plurality of competence values;
determine a role component based at least in part on the plurality of roles;
determine a skill distribution component based at least in part on a number of marketing technology tools classified into respective combinations of individual ones of the plurality of strategies and individual ones of the plurality of categories; and
generate a score based at least in part on the competence component, the role component, and the skill distribution component.

2. The system of claim 1, wherein the competence component comprises a sum of the plurality of competence values.

3. The system of claim 1, wherein the skill distribution component comprises an indication of an even distribution of marketing technology tools across the respective combinations of individual ones of the plurality of strategies and individual ones of the plurality of categories.

4. The system of claim 1, wherein the skill distribution component comprises an indication of an uneven distribution of marketing technology tools across the respective combinations of individual ones of the plurality of strategies and individual ones of the plurality of categories.

5. The system of claim 1, wherein the score corresponds to a user, and the program instructions, when executed, further direct the at least one computing device to at least generate an aggregate score corresponding to an organization based at least in part the score corresponding to the user and at least one other score corresponding to at least one other user.

6. The system of claim 1, wherein the score comprises a concatenation of the competence component, the role component, and the skill distribution component.

7. The system of claim 1, wherein the role component comprises a role from the plurality of roles having a highest frequency.

8. The system of claim 1, wherein the program instructions, when executed further cause the at least one computing device to at least:
receive a request for an assessment from the client device;
encode for rendering in a display of a client device at least one predefined assessment user interface; and
provide the at least one predefined assessment user interface to the client device.

9. The system of claim 1, wherein the program instructions, when executed further cause the at least one computing device to at least store the assessment data in a data store accessible to the at least one computing device.

10. The system of claim 1, wherein the program instructions, when executed further cause the at least one computing device to at least:
generate data representing at least one visualization associated with the assessment data;
encode for rendering in a display of the client device a user interface comprising the score and the at least one visualization associated with the assessment data; and
provide the user interface to the client device.

11. A computer-implemented method, comprising:
Receiving assessment data from a client device, the assessment data comprising a plurality of competence values and a plurality of roles, individual ones of the plurality of competence values and individual ones of the plurality of roles corresponding to a marketing technology tool from a marketing technology tool database, the marketing technology tool database classifying individual ones of a plurality of marketing technology tools into one of a plurality of strategies and one of a plurality of categories;
determining a competence component based at least in part on the plurality of competence values;
determining a role component based at least in part on the plurality of roles;
determining a skill distribution component based at least in part on a number of marketing technology tools classified into respective combinations of individual ones of the plurality of strategies and individual ones of the plurality of categories;
generating a score based at least in part on the competence component, the role component, and the skill distribution component; and
sending the score to the client device for rendering in a display device.

12. The method of claim 11, wherein the competence component comprises a sum of the plurality of competence values.

13. The method of claim 11, wherein the skill distribution component comprises an indication of an even distribution of marketing technology tools across the respective combinations of individual ones of the plurality of strategies and individual ones of the plurality of categories.

14. The method of claim 11, wherein the skill distribution component comprises an indication of an uneven distribution of marketing technology tools across the respective combinations of individual ones of the plurality of strategies and individual ones of the plurality of categories.

15. The method of claim 11, wherein the score corresponds to a user, the method further comprising generating an aggregate score corresponding to an organization based at least in part the score corresponding to the user and at least one other score corresponding to at least one other user.

16. The method of claim 11, wherein the score comprises a concatenation of the competence component, the role component, and the skill distribution component.

17. The method of claim 11, wherein the role component comprises a role from the plurality of roles having a highest frequency.

18. The method of claim 11, further comprising:
receiving a request for an assessment from the client device;
encoding for rendering in a display of the client device at least one predefined assessment user interface; and
providing the at least one predefined assessment user interface to the client device.

19. The method of claim 11, further comprising storing the assessment data in a data store.

20. The method of claim 11, further comprising:
generating data representing at least one visualization associated with the assessment data;
encoding for rendering in a display of the client device a user interface comprising the score and the at least one visualization; and
providing the user interface to the client device.
